(19) United States
(12) Patent Application Publication
(10) Pub. No.: US 2011/0263748 A1
(43) Pub. Date: Oct. 27, 2011

(54) PROCESS FOR PRODUCING CROSSLINKED ORGANIC POLYMERS

(75) Inventors: Stephanie SCHAUHOFF, Langen (DE); Martin TRAGESER, Gelnhausen-Hoechst (DE)

(73) Assignee: Evonik Degussa GmbH, Essen (DE)

(21) Appl. No.: 13/091,643

(22) Filed: Apr. 21, 2011

(30) Foreign Application Priority Data
Apr. 22, 2010 (DE) 10 2010 028062.3

(51) Int. Cl. C08F 283/04; C08J 3/28

(52) U.S. Cl. 522/138; 525/426

(57) ABSTRACT

The invention relates to a process for producing crosslinked organic polymers by reacting a polymer with a crosslinking agent from the group of the substituted cyanurates and isocyanurates, and also to novel compounds from the said group.

The invention relates to a process for producing crosslinked organic polymers by reacting a polymer with a crosslinking agent from the group of the substituted cyanurates and isocyanurates, and also to novel compounds from the said group.

### PRIOR ART

Plastics materials are subject to ever more stringent thermal requirements in relation to continuous service temperature and also to high short-term thermal stress. An example of the reason for a rise in continuous service temperatures in the automobile sector is the development of ever more powerful engines, and also continual improvements in soundproofing, which causes ever higher temperatures in the engine compartment. Automobile manufacturers are now demanding continuous service temperatures of up to 250° C. The standard rubber materials are therefore increasingly being replaced by materials with higher heat resistance or by high-melting point thermoplastics.

Applications in the electronics sector, e.g. “connectors”, “contact holders” or circuit boards, require materials which must withstand, without any change in their shape, short periods of very high temperatures which can sometimes be above their melting point, for example the temperatures that can arise during the soldering of metallic connections or in the event of overvoltage.

These requirements are met by using thermoplastics whose thermal stability is further increased by free-radical crosslinking. The crosslinking can in principle be markedly improved by coagents, e.g. triallyl cyanurate (TAC) or triallyl isocyanurate (TAICROS®).
However, the melting points and processing temperatures of the plastics materials that meet these stringent requirements (Engineering Polymers and High Performance Polymers), e.g. polyamides of PA 12, PA 11, PA 6, PA 66 or PA 46 type, or polyesters, are so high (>180° C.) that it becomes impossible to use, for example, TAC because it undergoes thermal polymerization at these temperatures. TAICROS has greater thermal stability and can therefore be used at temperatures which depend on processing times up to at most 250° C. However, it has the disadvantage of having relatively high vapour pressure at the said processing temperatures, and this leads to loss of crosslinking agent and especially to emission problems. It is therefore very difficult to ensure that the concentration of crosslinking agent within the compounded material is uniform.
In 2009, Nippon Kasei published a patent which provides, for elastomers and thermoplastics, novel modified crosslinking agents of the following structure:

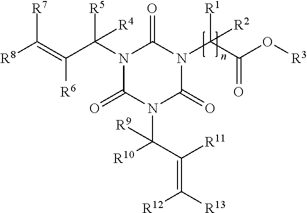

where these have the advantage of being solids and therefore being easier to incorporate on a roll or in an extruder, and having better compatibility in particular with fluoro rubbers, and therefore mitigating the problem of contamination of the mould.
However, the said compounds have the disadvantage of being only difunctional in relation to the free-radical crosslinking process, and accordingly having lower crosslinking efficiency. They also have the disadvantage that, having an ester group, they introduce into the material another function of relatively low chemical stability that can hydrolyze and liberate low-molecular-weight compounds, this being a disadvantage for the chemical stability of the crosslinked polymers. Nothing is known about the thermal stability or vapour pressure of the compound.

There is therefore a requirement for a thermally stable crosslinking agent which has vapour pressure markedly lower than that of TAICROS, but has comparable crosslinking efficiency and polymerization properties. No such crosslinking agent is currently available in the market.

The invention provides a process for producing a crosslinked organic polymer by reaction of a polymer with a crosslinking agent, characterized in that the crosslinking agent has the formula I

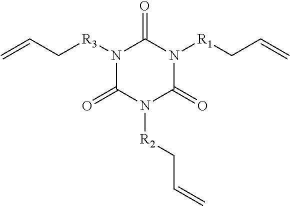

or the formula II

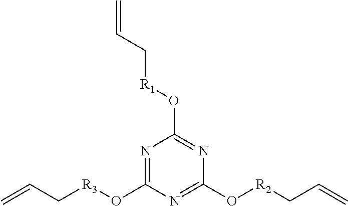

in which:

R¹, R², R³ are identical or different, being a divalent carbon moiety also termed spacer, selected from the group of

C₁ to C₂₀ alkylene, branched or unbranched, in particular C₁ to C₅, where the spacer optionally comprises heteroatoms selected from the group of nitrogen, sulphur or oxygen.

C₂ to C₂₀ alkenylene, branched or unbranched, in particular C₂ to C₅, where the spacer optionally comprises heteroatoms selected from the group of nitrogen, sulphur or oxygen,
C₅₋₁₂ cycloalkylene, cycloalkenylene or cycloalkyldienylene, mono- or binuclear, optionally substituted by 1 to 3 alkyl groups or alkenyl groups having respectively 1 to 3 carbon atoms.
C₆₋₁₄ divalent cycloaliphatic and/or aromatic, mono- or binuclear hydrocarbon moiety, optionally substituted by 1 to 4 alkyl groups or alkenyl groups having 1 to 2 carbon atoms, where the cycloaliphatic and/or aromatic, mono- or binuclear hydrocarbon moiety optionally comprises heteroatoms selected from the group of nitrogen, sulphur or oxygen.

Particular preference is given to compounds in which R¹, R² or R³ are identical and are a hydrocarbon moiety selected from the group of:

C₁-C₄-alkylene, unbranched, or

C₂-C₈-alkenylene, phenylene or cyclohexanylene.

Particularly selected compounds are trimethylallyl cyanurate, trimethylallyl isocyanurate, trihexenyl cyanurate, trihexenyl isocyanurate and triallylphenyl cyanurate and the corresponding isocyanurate (135:123157 CA, Synthesis and characterization of triallylphenoxytriazine and the properties of its copolymer with bismaleimide, Fang, Qiang; Jiang, Luxia, Journal of Applied Polymer Science (2001), 81(5), 1248-1257).

The molar mass of the compounds used is preferably ≧290 g/mol, in particular up to 600 g/mol, and the weight loss—determined by way of thermogravimetric analysis (conditions: from RT to 350° C., heating rate 10 K/min in air) is preferably less than 20% by weight up to 250° C. and, respectively, the vapour pressure is preferably <20 mbar at 200° C.

The process according to the invention is particularly suitable for thermoplastic polymers, e.g. polyvinyl polymere, polyolefins, polystyrenes, polyacrylates, polymethacrylates, polyesters, polyamides, polycarbonates, polyphenylene ethers, polyphenylene sulphides, polyacetals, polyphenylene sulphones, fluoropolymers or mixtures of these, to the extent that they are known to be compatible with one another.

Preference is given to high-melting-point polymers with melting points>180° C., examples being polystyrenes, polyesters, polyamides, polycarbonates, polyphenylene ethers, polyphenylene sulphide, polyacetals, polyphenylene sulphones, fluoropolymers or mixtures of these, to the extent that they are known to be compatible with one another.

Particular preference is given to polyamides and polyesters or a mixture of these.

Mixtures made of the molten polymers and of the compounds acting as crosslinking agents are then produced according to the prior art at a processing temperature which is equal to the melting point of the polymer or oligomer, or is higher.

According to the invention, the amount used of the compounds according to the formulae I or II is from 0.01 to 10% by weight, in particular from 0.5 to 7% by weight, particularly preferably from 1 to 5% by weight, based on the crosslinkable monomer, oligomer and/or polymer.

The amount of the crosslinking agent generally depends on the specific polymer and on the intended application sector for the said polymer. Combination with other crosslinking components is not excluded, but is not necessary.

The crosslinking process can take place by a peroxidic route or by electron-beam crosslinking. In the case of the high-melting-point polymers which are particularly preferably used according to the invention, the only process that can be used is electron-beam crosslinking, which takes place at room temperature, whereas the processing temperature of peroxides is at most 150° C. and the crosslinking temperature in the case of peroxidically crosslinked systems is 160 to 190° C. Peroxidic crosslinking is therefore preferably used in the case of polymers or oligomers with a melting point of 100 to 150° C.

However, the crosslinking agents used according to the invention are also suitable for the crosslinking of elastomers that can be crosslinked by a free-radical route, examples being natural rubber, isoprene rubber, butadiene rubber, ethylene-propylene rubber, nitrile rubber, hydrogenated nitrile rubber, chloroprene rubber, chlorosulphonylpolyethylene, polyacrylate rubber, ethylene-acrylate rubber, fluoro rubber, ethylene-vinyl acetate copolymers, silicone rubber, or a mixture of these, where they provide advantages in particular in the case of relatively high processing temperatures and have better compatibility with nonpolar elastomers, e.g. fluoro rubber, because of the relatively long side chains.

The invention also provides compounds of the general formula I

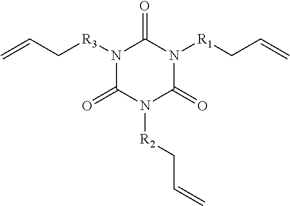

or of the formula II

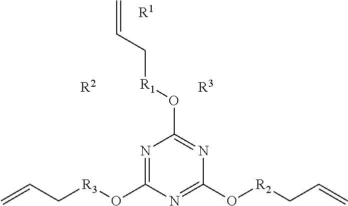

in which:

R¹, R², R³ are identical or different, being a divalent carbon moiety also termed spacer, selected from the group of

C₁ to C₂₀ alkylene, branched or unbranched, in particular C₁ to C₆, where the spacer optionally comprises heteroatoms selected from the group of nitrogen, sulphur or oxygen.

C₂ to C₂₀ alkenylene, branched or unbranched, in particular C₂ to C₈, where the spacer optionally comprises heteroatoms selected from the group of nitrogen, sulphur or oxygen,
C₅₋₁₂ cycloalkylene, cycloalkenylene or cycloalkyldienylene, mono- or binuclear, optionally substituted by 1 to 3 alkyl groups or alkenyl groups having respectively 1 to 3 carbon atoms.
C₆₋₁₄ divalent cycloaliphatic and/or aromatic, mono- or binuclear hydrocarbon moiety, optionally substituted by 1 to 4 alkyl groups or alkenyl groups having 1 to 3 carbon atoms, where the cycloaliphatic and/or aromatic, mono- or binuclear hydrocarbon moiety optionally comprises heteroatoms selected from the group of nitrogen, sulphur or oxygen, with the exception of the following compounds: trialkylphenyl cyanurate, tris(2-methyl-2-propenyl)cyanurate and tributenyl isocyanoisocyanurate.

Particular preference is given to compounds in which:

R¹, R² and R³ are identical, selected from the following group:

C₁-C₄-alkylene, unbranched,

C₂-C₈-alkenylene,

phenylene, cyclohexanylene.

The nomenclature of the hydrocarbon moieties corresponds to that in the Handbook of Chemistry and Physics, 52^{nd} Edition, 1972-1972.

The following process is used to produce the compounds used:

TAC analogues (corresponding to formula II):

The alcohols or compounds comprising OH groups that correspond to the substituents are used as initial charge with a certain amount of water, with cooling, and cyanuric chloride and sodium hydroxide solution are then metered simultaneously into the mixture over a period of from 1 to 2 hours at reaction temperatures of 5 to 20° C., mostly 7 to 15° C. Addition is followed by work-up and separation of the organic matrix through addition of water and corresponding separation of the phases.

The organic matrix is then freed by distillation from residues of water and from solvent (alcohols used and, respectively, compounds comprising OH groups), thus giving the target products.

The alcohols or compounds comprising OH groups that are reclaimed by distillation can be reintroduced into the process. The syntheses use the following molar cyanuric chloride:alcohol/compound comprising OH groups:sodium hydroxide solution ratios: 1.0:3.3:3.1 to 1.0:6.0:3.5, but in particular 1.0:5.1:3.36.

The identity of the compounds was confirmed by way of HPLC-MS.

TAICROS analogues (corresponding to formula I)

The syntheses use sodium cyanurate (trisodium salt of isocyanuric acid) and the corresponding alkene chlorides and, respectively, chloride-substituted compounds, in particular in dimethylformamide as solvent, where all of the components are preferably used together as initial charge and are then reacted for 5 to 8 hours at 120 to 145° C. After cooling, the mixture is filtered to remove it from the salt, and the resultant organic phase is freed from the dimethylformamide by distillation in vacuo, thus giving the target products.

The syntheses use the reactants sodium cyanurate and chlorides in a molar ratio of 1:3.

The identity of the compounds was confirmed by way of HPLC-MS.

The invention likewise provides crosslinkable compositions comprising a polymer selected from the group of:

polyvinyl polymers, polyolefins, polystyrenes, polyacrylates, polymethacrylates, polyesters, polyamides, polycarbonates, polyphenylene ethers, polyphenylene sulphides, polyacetals, polyphenylene sulphones, fluoropolymers or a mixture of these, in particular polyamides and polyesters or a mixture of these, or elastomers selected from the group of: natural rubber, isoprene rubber, butadiene rubber, ethylene-propylene rubber, nitrile rubber, hydrogenated nitrile rubber, chloroprene rubber, chlorosulphonylpolyethylene, polyacrylate rubber, ethylene-acrylate rubber, fluoro rubber, ethylene-vinyl acetate copolymers, silicone rubber, or a mixture of these, and a compound according to the formulae I or II.

### EXAMPLES

Performance Tests on the Crosslinking Agents:

The following compounds are used in the examples:

TAC: triallyl cyanurate

TAIC (TAICROS®): triallyl isocyanurate

TMAC: trimethylallyl cyanurate

TMAIC: trimethylallyl isocyanurate

THC: trihexenyl cyanurate

THIC: trihexenyl isocyanurate

TAPC: triallylphenyl cyanurate

1. Properties of the Crosslinking Agents:

1.1 Weight Loss on Heating:

As shown in the table below, the novel compounds have markedly lower vapour pressure than TAIC. This is seen in a markedly lower weight loss on heating to relatively high temperature.

TABLE 1

| | TAC | TAIC | TMAIC | TMAC | THC | THIC | TAPC |
|---|---|---|---|---|---|---|---|
| MM [g/mol] | 249.27 | 249.27 | 291.35 | 291.35 | 375.51 | 375.51 | 477.55 |
| TGA (conditions: RT to 350° C., | | | | | | | |
| heating rate 10 K/min in air) | | | | | | | |
| Weight loss (%) at | | | | | | | |
| 200° C. | 1.9 | 3.7 | 2.0 | 0.9 | 1.1 | 4.9 | 0.8 |
| 250° C. | 14.6 | 26.1 | 15.1 | 5.4 | 2.6 | 6.4 | 0.9 |
| 300° C. | 47.7* | 99.8 | 61.8 | 36.3 | 12.9 | 10.9 | 3.0 |
| 350° C. | 48.4* | 99.9 | 69.3* | 65.4 | 36.5 | 24.6 | 16.2 |

*Material polymerizes!!

1.2 Thermal Stability:

In order to investigate thermal stability, small amounts (50-100 mg) of the substances were stored at various temperatures, and the change in monomer content was monitored as a function of time by means of HPLC analysis. All of the compounds here had been stabilized with 100 ppm of MEHQ (methylhydroquinone).

The tables below state the residual monomers contents in %:

TABLE 2
160° C.

| Time | TAC | TAICROS | TAICROS M | TMAC | THC | THIC | TAPC |
|---|---|---|---|---|---|---|---|
| (hours) | Content [%] | Content [%] | Content [%] | Content [%] | Content [%] | Content [%] | Content [%] |
| 0 | 100 | 100 | 100 | 100.0 | 100.0 | 100.0 | 100.0 |
| 1 | 90 | 98 | 100 | 100.0 | 100.0 | 100.0 | 100.0 |
| 5 | 0 | 96.2 | 100 | 100.0 | 100.0 | 100.0 | 100.0 |

TABLE 3
200° C.

| Time | TAC | TAICROS | TAICROS M | TMAC | THC | THIC | TAPC |
|---|---|---|---|---|---|---|---|
| (min) | Content [%] | Content [%] | Content [%] | Content [%] | Cotent [%] | Content [%] | Content [%] |
| 0 | 100.0 | 100.0 | 100.0 | 100.0 | 100 | 100 | 100 |
| 2 | 94.5 | 100.0 | 94.3 | 96.7 | 96.2 | 93.5 | 90.9 |
| 5 | 53.8 | 85.4 | 84.7 | 79.7 | 91.8 | 92.6 | 79.3 |
| 10 | 41.1 | 23.6 | 74.5 | 52.1 | 81.2 | 90.7 | 71.6 |

TABLE 4
225° C.

| Time | TAC | TAICROS | TAICROS M | TMAC | THC | THIC | TAPC |
|---|---|---|---|---|---|---|---|
| (min) | Content [%] | Content [%] | Content [%] | Content [%] | Content [%] | Content [%] | Content [%] |
| 0 | 100.0 | 100.0 | 100.0 | 100.0 | 100 | 100 | 100 |
| 2 | 0 * | 60.8 | 89.2 | 73.1 | 88.2 | 88.5 | 80.3 |
| 5 | 0 * | 24.0 | 73.8 | 47.6 | 75.4 | 76.9 | 66.3 |
| 10 | 0 * | 21.6 | 65.8 | 36.2 | 56.5 | 65 | 49.1 |

TABLE 5
250° C.

| time | TAC | TAICROS | TAICROS M | TMAC | THC | THIC | TAPC |
|---|---|---|---|---|---|---|---|
| (min) | Content [%] | Content [%] | Content [%] | Content [%] | Content [%] | Content [%] | Content [%] |
| 0 | n.d. | 100.0 | 100.0 | 100 | 100 | 100 | 100 |
| 2 | n.d. | 43.6 | 72.7 | 46.9 | 77.1 | 78.5 | 78.0 |
| 5 | n.d. | 25.4 | 63.7 | 31.2 | 42 | 60.2 | 46.8 |
| 10 | n.d. | 24.3 | 58.5 | 28.8 | 29.9 | 38.1 | 27.2 |

* Polymer, residual monomer content not determined

The novel compounds can withstand markedly higher processing temperatures for short periods and, respectively, exhibit markedly slower thermally induced homopolymerization.

2. Application Examples:

Nylon-6 (Ultramid B3K, BASF) was compounded in an extruder with respectively 3% by weight of TAICROS® (Evonik), THC and TAPC.

Nylon-6,6 (Ultramid A3K) was analogously mixed in an extruder with respectively 3% by weight of THC and TAPC. The extrusion process with TAIC was not possible with PA 66 because of the excessive vapour pressure and onset of polymerization.

To facilitate feed of the crosslinking agents, these were in the form of a masterbatch when they were metered into the mixture. In the case of the liquid crosslinking agents, the masterbatches were produced by direct absorption of the liquids onto a porous polyamide (Accurell MP 700), and in the case of the solid crosslinking agents, the masterbatches were produced by absorbing a solution of the crosslinking agent onto Accurell and then drying. The concentration of the masterbatches was 30%, i.e. 10% of PA masterbatch (PA MB) was admixed. For comparison, polyamide specimens were extruded with pure Accurell MP 700.

In the case of PA 6 with TAICROS, marked “misting” (loss of TAICROS through evaporation from the polymer extrudate) was observed during the compounding process, with associated unpleasant odour at the extruder outlet. This was not observed with the two novel crosslinking agents TAC and TAPC.

2.1 MFI:

After the extrusion process, the MFI (melt flow index) was investigated in order to discover whether “prepolymerization” has occurred during the compounding process. The MFI is somewhat reduced by extrusion with pure Accurell, i.e. melt viscosity rises somewhat.

In comparison, the MFI reduction caused by both TAICROS and THC for PA 6 is slight, and the amount of incipient crosslinking can therefore be concluded to be minimal. TAICROS M has no effect on MFI, whereas TAPC causes a marked increase in MFI, i.e. a reduction of melt viscosity. The reason for this is thought to be that the compound acts as lubricant.

In PA 66, all of the crosslinking agents tested caused a slight increase in MFI. It appears that the lubricant action becomes more noticeable at the higher temperature of determination: 280° C. in comparison with 250° C. It can certainly be assumed that no significant premature crosslinking has occurred during the compounding process.

TABLE 6

| | MFI |
|---|---|
| | (250° C./2.16 kg) |
| PA 6 | g/10 min. |
| PA 6 starting | 35.0 |
| material | |
| PA 6 + PA 6 porous | 31.7 |
| extr. | |
| PA 6 + 3% TAICROS | 27.9 |
| (PA MB) | |
| PA 6 + 3% TAICROS M | 32.7 |
| (PA MB) | |
| PA 6 + 3% THC (PA | 25.3 |
| MB) | |
| PA 6 + 3% TAPC (PA | 44.8 |
| MB) | |

TABLE 7

| | MFI |
|---|---|
| | (280° C./2.16 kg) |
| PA 66 | g/10 min. |
| PA 66 starting | 52.8 |
| material | |
| PA 66 + PA 6 porous | 46.3 |
| extr. | |
| PA 66 + 3% TAICROS | 55.8 |
| M (PA MB) | |
| PA 66 + 3% THC (PA | 56.5 |
| MB) | |
| PA 66 + 3% TAPC (PA | 89.2 |
| MB) | |

2.2 Degree of Crosslinking:

Pelletized specimens of all of the mixtures were then electron-beam crosslinked with 120 and 200 kGy. The degree of crosslinking was then determined as follows on the pelletized specimens by way of the gel content:

Respectively about 1.0 g of the pellets were weighed into the apparatus and 100 ml of m-cresol were admixed, and the mixture was heated to boiling point, with stirring, and refluxed for at least 3 hours. After this time, the uncrosslinked polyamide had dissolved completely. In the case of the crosslinked specimens, the insoluble fraction was removed by filtration and washed with toluene. The residues were then dried for up to 7 hours at 120° C. in a vacuum oven, and weighed. The insoluble fraction corresponds to the degree of crosslinking.

TABLE 8

| | Gel content |
|---|---|
| | (120 kGy) |
| PA 6 | % |
| PA 6 starting | 5.85 |
| material | |
| PA 6 + 3% TAICROS | 100 |
| (PA MB) | |
| PA 6 + 3% TAICROS M | 100 |
| (PA MB) | |
| PA 6 + 3% THC (PA | 100 |
| MB) | |
| PA 6 + 3% TAPC (PA | 100 |
| MB) | |

TABLE 9

| | Gel content |
|---|---|
| | (120 kGy) |
| PA 66 | % |
| PA 66 starting | 0.67 |
| material | |
| PA 66 + 3% TAICROS M | 100 |
| (PA MB) | |
| PA 66 + 3% THC (PA | 100 |
| MB) | |
| PA 66 + 3% TAPC (PA | 100 |
| MB) | |

All of the mixtures were completely crosslinked even at 120 kGy, and no determination was therefore then made of gel contents of the specimens crosslinked at 200 kGy.

2.3 Entanglement Density:

Further information about the crosslinking process is provided by the “entanglement density” calculated from the modulus of elasticity in accordance with the following formula:

E/3=n×k×T, where

n=entanglement density

k=Bolzmann constant=1.38×1023 J/K

T=temperature in K

The resultant values are as follows: see table. In comparison with the gel content, this method gives a less pronounced difference with respect to PA without crosslinking agent, but nevertheless reveals a marked increase in the entanglement density due to the crosslinking agents. The slightly lower values with the novel crosslinking agents in comparison with TAICROS are thought to be attributable to the relatively high molecular weights, i.e. smaller number of mols for 3% addition, where TAPC is slightly more efficient than THC.

TABLE 10

| | | | | PA 6 + | PA 6 + |
|---|---|---|---|---|---|
| | | PA 6 + | | 3% | 3% |
| | | 3% | PA 6 + 3% | THC | TAPC |
| | PA 6 | TAICROS | TAICROS | (PA | (PA |
| Description | extruded | (PA MB) | M (PA MB) | MB) | MB) |
| Irradiation | no EB | none | none | none | none |
| Entanglement | 1.98 | 1.81 | 1.85 | 1.78 | 1.94 |
| density | | | | | |
| Irradiation | 120 kGy | 120 | 120 | 120 | 120 |
| Entanglement | 2.06 | 2.20 | 2.15 | 2.07 | 2.12 |
| density | | | | | |
| Irradiation | 200 kGy | 200 | 200 | 200 | 200 |
| Entanglement | 2.10 | 2.22 | 2.20 | 2.15 | 2.20 |
| density | | | | | |

TABLE 11

| | | PA 66 + | | PA 66 + |
|---|---|---|---|---|
| | | 3% | PA 66 + | 3% TAPC |
| | PA 66 | TAICROS M | 3% THC | (PA |
| Description | extruded | (PA MB) | (PA MB) | MB) |
| Irradiation | no EB | none | none | none |
| Entanglement | 2.08 | 2.14 | 2.02 | 2.12 |
| density | | | | |
| Irradiation | 120 kGy | 120 | 120 | 120 |
| Entanglement | 2.18 | 2.33 | 2.26 | 2.28 |
| density | | | | |
| Irradiation | 200 kGy | 200 | 200 | 200 |
| Entanglement | 2.19 | 2.37 | 2.32 | 2.35 |
| density | | | | |

2.4 Residual Crosslinking Agent Content:

Residual crosslinking agent content was also determined on the crosslinked pellets, by total extraction with methanol. All of the crosslinking agents were found to have undergone >99% reaction even at 120 kGy.

TABLE 12

| | Residual | Residual |
|---|---|---|
| | crosslinking | crosslinking |
| | agent content | agent content |
| | after | after |
| | irradiation with | irradiation |
| | 120 kGy | with 200 kGy |
| PA 6 | % | % |
| PA 6 starting | 0.00 | 0.00 |
| material | | |
| PA 6 + 3% TAICROS | 0.00 | 0.00 |
| (PA MB) | | |
| PA 6 + 3% TAICROS M | 0.05 | 0.00 |
| (PA MB) | | |
| PA 6 + 3% THC (PA | 0.67 | 0.43 |
| MB) | | |
| PA 6 + 3% TAPC (PA | 0.02 | 0.00 |
| MB) | | |

TABLE 13

| | Residual | Residual |
|---|---|---|
| | crosslinking | crosslinking |
| | agent content | agent content |
| | after | after |
| | irradiation | irradiation with |
| | with 120 kGy | 200 kGy |
| PA 66 | % | % |
| PA 66 starting | 0.00 | 0.00 |
| material | | |
| PA 66 + 3% TAICROS | 0.30 | 0.00 |
| M (PA MB) | | |
| PA 66 + 3% THC (PA | 0.16 | 0.13 |
| MB) | | |
| PA 66 + 3% TAPC | 0.00 | 0.00 |
| (PA MB) | | |

2.5 Short-Term Heat Resistance (Soldering-Iron Test):

A “soldering-iron test” was also carried out on the pellets. Here, a metal rod at high temperature was pressed with defined pressure onto the test specimen for a few seconds and the penetration depth was measured. This test simulates high short-term thermal stress, for which the materials described here are particularly suitable.

TABLE 14

| PA 6 | Irradiation dose/kGy | | |
|---|---|---|---|
| after extrusion | 0 | 120 | 200 |
| PA 6 starting | 2.07 | n.d. | n.d. |
| material | | | |
| PA 6 + PA 6 porous | 2.37 | 2.37 | 2.26 |
| extr. | | | |
| PA 6 + 3% TAICROS | 2.05 | 0.18 | 0.16 |
| (PA MB) | | | |
| PA 6 + 3% TAICROS M | 2.17 | 0.29 | 0.30 |
| (PA MB) | | | |
| PA 6 + 3% THC (PA | 2.13 | 0.83 | 0.48 |
| MB) | | | |
| PA 6 + 3% TAPC (PA | 2.24 | 2.01 | 1.39 |
| MB) | | | |

TABLE 15

| | Irradiation dose/kGy | | |
|---|---|---|---|
| PA 66 | 0 | 120 | 200 |
| PA 66 starting | 1.57 | n.d. | n.d. |
| material | | | |
| PA 66 + PA 6 porous | 1.72 | 1.61 | 1.63 |
| extr. | | | |
| PA 66 + 3% TAICROS | 1.79 | 0.23 | 0.21 |
| M (PA MB) | | | |
| PA 66 + 3% THC (PA | 1.77 | 0.49 | 0.30 |
| MB) | | | |
| PA 66 + 3% TAPC (PA | 1.76 | 1.16 | 1.27 |
| MB) | | | |

The results confirm that addition of the crosslinking agents considerably increases the crosslinking of the polyamide, thus achieving high thermomechanical stability/heat resistance for short-term stress. The differences between the crosslinking agents result for the most part from the different molecular weights, and TAPC appears here to have a tendency to be somewhat poorer in relation to this property than THC.

In order to ensure that the other mechanical properties of the materials also meet the requirements, test specimens were produced from the compounded materials and electron-beam-crosslinked under conditions identical with those above, and mechanical properties were determined in the tensile test; heat distortion temperature (HDT) was also determined.

2.6 Long-Term Heat-Distortion Temperature (HDT):

The novel crosslinking agents, like TAICROS and TAICROS M, improve the heat distortion temperature (HDT) of the polyamide. The values with the novel crosslinking agents have a tendency to be lower and are thought, as mentioned above, to be attributable to a smaller number of crosslinking sites by virtue of the higher molecular weight, i.e. a smaller number of mols for 3% addition.

TABLE 16

| | HDT | Irradiation dose/kGy | | |
|---|---|---|---|---|
| PA 6 | Method | 0 | 120 | 200 |
| PA 6 without | A | 51 | 54 | 55 |
| crosslinking agent | | | | |
| PA 6 + 3% TAICROS | A | 49 | 63 | 69 |
| (PA MB) | | | | |
| PA 6 + 3% TAICROS M | A | 50 | 64 | 64 |
| (PA MB) | | | | |
| PA 6 + 3% THC (PA | A | 49 | 60 | 60 |
| MB) | | | | |
| PA 6 + 3% TAPC (PA | A | 50 | 61 | 60 |
| MB) | | | | |
| PA 6 starting | B | 183 | 180 | 180 |
| material | | | | |
| PA 6 + 3% TAICROS | B | n.d. | 179 | 183 |
| (PA MB) | | | | |
| PA 6 + 3% TAICROS M | B | 183 | 187 | 184 |
| (PA MB) | | | | |
| PA 6 + 3% THC (PA | B | 159 | 183 | 187 |
| MB) | | | | |
| PA 6 + 3% TAPC (PA | B | 169 | 180 | 183 |
| MB) | | | | |

TABLE 17

| | HDT | Irradiation dose/kGy | | |
|---|---|---|---|---|
| PA 66 | Method | 0 | 120 | 200 |
| PA 66 starting | A | 60 | 67 | 66 |
| material | | | | |
| PA 66 + 3% TAICROS | A | 61 | 77 | 77 |
| M (PA MB) | | | | |
| PA 66 + 3% THC (PA | A | 58 | 82 | 76 |
| MB) | | | | |
| PA 66 + 3% TAPC (PA | A | 56 | 69 | 74 |
| MB) | | | | |
| PA 66 starting | B | 207 | 210 | 213 |
| material | | | | |
| PA 66 + 3% TAICROS | B | 220 | 223 | 225 |
| M (PA MB) | | | | |
| PA 66 + 3% THC (PA | B | 208 | 223 | 222 |
| MB) | | | | |
| PA 66 + 3% TAPC (PA | B | 216 | 216 | 216 |
| MB) | | | | |

2.7 Mechanical Properties:

As far as mechanical properties are concerned, TAPC exhibits greater brittleness than THC.

Tensile Tests in Accordance with ISO 527 on PA 6 and 6.6, Dumbbell Specimens

TABLE 18

| | | | PA 6 + 3% | PA 6 + 3% | PA 6 + 3% | PA 6 + 3% |
|---|---|---|---|---|---|---|
| | | PA 6 | TAICROS | TAICROS M | THC | TAPC |
| Description | | extruded | (PA MB) | (PA MB) | (PA MB) | (PA MB) |
| Irradiation | | no EB | none | none | none | none |
| Modulus of | MPA | 2396 | 2201 | 2242 | 2157 | 2358 |
| elasticity Eₜ | | | | | | |
| Tensile | MPa | 61.0 | 58.9 | 59.9 | 57.2 | 56.2 |
| strength Q_{M} | | | | | | |
| Tensile strain | % | 75 | 105 | 61 | 83 | 32 |
| at break ε_{B} | | | | | | |
| Irradiation | kGy | 120 kGy | 120 | 120 | 120 | 120 |
| Modulus of | MPA | 2496 | 2666 | 2608 | 2510 | 2568 |
| elasticity Eₜ | | | | | | |
| Tensile | MPa | 64.8 | 71.3 | 71.7 | 67.1 | 69.7 |
| strength Q_{M} | | | | | | |
| Tensile strain | % | 56 | 47 | 33 | 92 | 35 |
| at break ε_{B} | | | | | | |
| Irradiation | kGy | 200 kGy | 200 | 200 | 200 | 200 |
| Modulus of | MPA | 2542 | 2698 | 2666 | 2606 | 2674 |
| elasticity Eₜ | | | | | | |
| Tensile | MPa | 65.6 | 73.1 | 72.5 | 68.4 | 70.9 |
| strength Q_{M} | | | | | | |
| Tensile strain | % | 61 | 40 | 36 | 56 | 38 |
| at break ε_{B} | | | | | | |

| | | | PA 66 + 3% | PA 66 + 3% | PA 66 + 3% |
|---|---|---|---|---|---|
| | | PA 66 | TAICROS M | THC | TAPC |
| Description | | extruded | (PA MB) | (PA MB) | (PA MB) |
| Irradiation | | none | none | none | none |
| Modulus of | MPA | 2519 | 2598 | 2450 | 2572 |
| elasticity Eₜ | | | | | |
| Tensile | MPa | 68.4 | 70.1 | 68.5 | 70.0 |
| strength Q_{M} | | | | | |
| Tensile strain | % | 69 | 42 | 43 | 48 |
| at break ε_{B} | | | | | |
| Irradiation | kGy | 120 | 120 | 120 | 120 |
| Modulus of | MPA | 2640 | 2825 | 2743 | 2760 |
| elasticity Et | | | | | |
| Tensile | MPa | 70.7 | 77.6 | 76.4 | 75.2 |
| strength Q_{M} | | | | | |
| Tensile strain | % | 54 | 31 | 40 | 35 |
| at break ε_{B} | | | | | |
| Irradiation | kGy | 200 | 200 | 200 | 200 |
| Modulus of | MPA | 2662 | 2880 | 2818 | 2847 |
| elasticity Eₜ | | | | | |
| Tensile | MPa | 71.1 | 78.4 | 77.0 | 76.3 |
| strength Q_{M} | | | | | |
| Tensile strain | % | 43 | 29 | 45 | 39 |
| at break ε_{B} | | | | | |

1. Process for producing a crosslinked organic polymer by reaction of a polymer with a crosslinking agent, wherein the crosslinking agent has the formula I 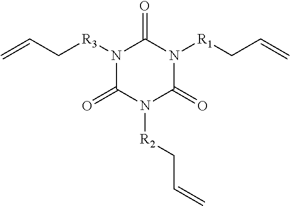
or the formula II 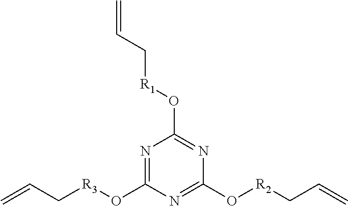
in which:
R¹, R², R³ are identical or different, being a divalent carbon moiety also termed spacer, selected from the group of
C₁ to C₂₀ alkylene, branched or unbranched, in particular C₁ to C₆, where the spacer optionally comprises heteroatoms selected from the group of nitrogen, sulphur or oxygen.
C₂ to C₂₀ alkenylene, branched or unbranched, in particular C₂ to C₈, where the spacer optionally comprises heteroatoms selected from the group of nitrogen, sulphur or oxygen,
C₅₋₁₂ cycloalkylene, cycloalkenylene or cycloalkyldienylene, mono- or binuclear, optionally substituted by 1 to 3 alkyl groups or alkenyl groups having respectively 1 to 3 carbon atoms.
C₆₋₁₄ divalent cycloaliphatic and/or aromatic, mono- or binuclear hydrocarbon moiety, optionally substituted by 1 to 4 alkyl groups or alkenyl groups having 1 to 3 carbon atoms, where the cycloaliphatic and/or aromatic, mono- or binuclear hydrocarbon moiety optionally comprises heteroatoms selected from the group of nitrogen, sulphur or oxygen.

2. Process according to claim 1, wherein R¹, R², R³ are identical and selected from the group of:
C₁-C₄-alkylene, unbranched,
C₂-C₈-alkenylene, phenylene, cyclohexanylene.

3. Process according to claim 1, wherein the polymers used comprise thermoplastic polymers selected from the group consisting of polyvinyl polymers, polyolefins, polystyrenes, polyacrylates, polymethacrylates, polyesters, polyamides, polycarbonates, polyphenylene ethers, polyphenylene sulphides, polyacetals, polyphenylene sulphones, fluoropolymers or mixtures of these, to the extent that they are known to be compatible with one another.

4. Process according to claim 1, wherein the amount of the compound used according to the formula I or II is from 0.01 to 10% by weight, based on the crosslinkable polymer.

5. Process according to claim 1, wherein the method of crosslinking varies with the polymer to be crosslinked, either consisting in addition of a suitable peroxide at a temperature of 160 to 190° C. or consisting in electron-beam crosslinking at room temperature.

6. Compounds of the general formula I 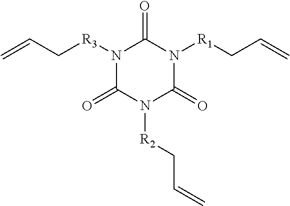
or of the formula II 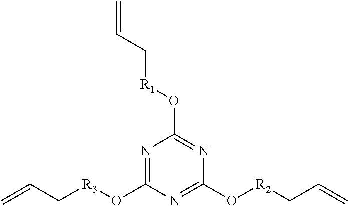
in which:
R¹, R², R³ are identical or different, being a divalent carbon moiety also termed spacer, selected from the group of
C₁ to C₂₀ alkylene, branched or unbranched, in particular C₁ to C₆, where the spacer optionally comprises heteroatoms selected from the group of nitrogen, sulphur or oxygen.
C₂ to C₂₀ alkenylene, branched or unbranched, in particular C₂ to C₈, where the spacer optionally comprises heteroatoms selected from the group of nitrogen, sulphur or oxygen,
C₅₋₁₂ cycloalkylene, cycloalkenylene or cycloalkyldienylene, mono- or binuclear, optionally substituted by 1 to 3 alkyl groups or alkenyl groups having respectively 1 to 3 carbon atoms.
C₆₋₁₄ divalent cycloaliphatic and/or aromatic, mono- or binuclear hydrocarbon moiety, optionally substituted by 1 to 4 alkyl groups or alkenyl groups having 1 to 2 carbon atoms, where the cycloaliphatic and/or aromatic, mono- or binuclear hydrocarbon moiety optionally comprises heteroatoms selected from the group of nitrogen, sulphur or oxygen, with the exception of the following compounds: trialkylphenyl cyanurate, tris(2-methyl-2-propenyl)cyanurate and tributenylisocyanurate.

7. Crosslinkable composition comprising a polymer selected from the group consisting of polyvinyl polymers, polyolefins, polystyrenes, polyacrylates, polymethacrylates, polyesters, polyamides, polycarbonates, polyphenylene ethers, polyphenylene sulphides, polyacetals, polyphenylene sulphones, fluoropolymers or mixtures of these, to the extent that they are known to be compatible with one another, and a compound according to the formula I or II.
